(19) United States
(12) Patent Application Publication
(10) Pub. No.: US 2010/0288258 A1
(43) Pub. Date: Nov. 18, 2010

(54) TILE SAW HAVING A TABLE SUPPORT RAIL PROTECTION DEVICE

(76) Inventors: Yang Cao, Nanjing (CN); Hongge Wei, Nanjing (CN); Haiyu Ji, Nanjing (CN); Banglin Guan, Nanjing (CN)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/780,252

(22) Filed: May 14, 2010

(30) Foreign Application Priority Data
May 14, 2009 (CN) 200920045297.8

(51) Int. Cl. B28D 1/04; B28D 7/02

(52) U.S. Cl. 125/13.01; 451/453; 451/455

(57) ABSTRACT

The tile saw of the present invention has a frame with a first guide rail and a second guide rail, a water tray coupled to the frame and a table for supporting a work-piece to be cut supported by at least one of the first and second guide rails. The tile saw also has a supporting arm mounted on the frame and a cutting machine supported by the supporting arm. In the present invention, one of the first or second guide rails is located outside of the water tank and the tile saw has a rail protective device for protecting the guide rail from damage. As a result, the tile saw of the present invention protects the guide rail from both dirty water and dust produced during the cutting process.

### CROSS-REFERENCE TO RELATED APPLICATIONS

This application claims priority under 35 U.S.C. §119 to CN 200920045297.8 filed May 14, 2009, which is hereby incorporated by reference.

### FEDERALLY SPONSORED RESEARCH OR DEVELOPMENT

Not Applicable.

### TECHNICAL FIELD

The invention relates to a tile saw. More specifically, it relates to a table saw designed for cutting masonries and ceramic tiles having a protection device for the table support rail.

### BACKGROUND OF THE INVENTION

A tile saw is widely used for cutting materials such as masonries and ceramic tiles. Typically, a tile saw contains a power head assembly, a table, a base for supporting the table and a water tray located under the base. A rail structure may be arranged on the base and rollers and can be mounted on the bottom surface of the table to engage with the rail structure. As a result, the table may then be slidable on the base by using the rollers in combination with the track structure. In the prior art, the track structure of the base is exposed to the water tray. As a result, the guide rails frequently get damaged by dirty water in the water tray or from the dust created during the cutting process. When the guide rails are dirty and are used, the harsh particles that reside in the dirty water or the dust rub against the guide rails of the table on the track and result in premature deterioration of the guide rails, inaccuracy of the guide rails and incorrect cutting of the material.

### SUMMARY OF THE INVENTION

The object of this invention is to provide a tile saw with a protection device for protecting the rail structure from being polluted or damaged by water from the water tray or particles from the cutting process.

The tile saw of the present invention has a frame with a first guide rail and a second guide rail, a water tray coupled to the frame and a table for supporting a work-piece to be cut supported by at least one of the first and second guide rails. The tile saw also has a supporting arm mounted on the frame and a cutting machine supported by the supporting arm. In the present invention, one of the first or second guide rails is located outside of the water tray and the tile saw has a rail protective device for protecting a guide rail from damage.

Specifically, the tile saw of the present invention protects the guide rail from the dirty water and dust produced during the cutting process which prevents the rail from being damaged and prolongs the working life of the guide rails to help maintain the overall operational effectiveness of the tile saw.

### BRIEF DESCRIPTION OF THE DRAWINGS

The invention will be further described in detail in combination of the following accompanying drawings and embodiments.

FIG. 1 is a perspective view of a tile saw according to a preferred embodiment of the present invention;

FIG. 2 is an exploded view of the tile saw shown in FIG. 1;

FIG. 3 is a sectional view of a portion of the water tray of the tile saw shown in FIG. 1.

### DETAILED DESCRIPTION

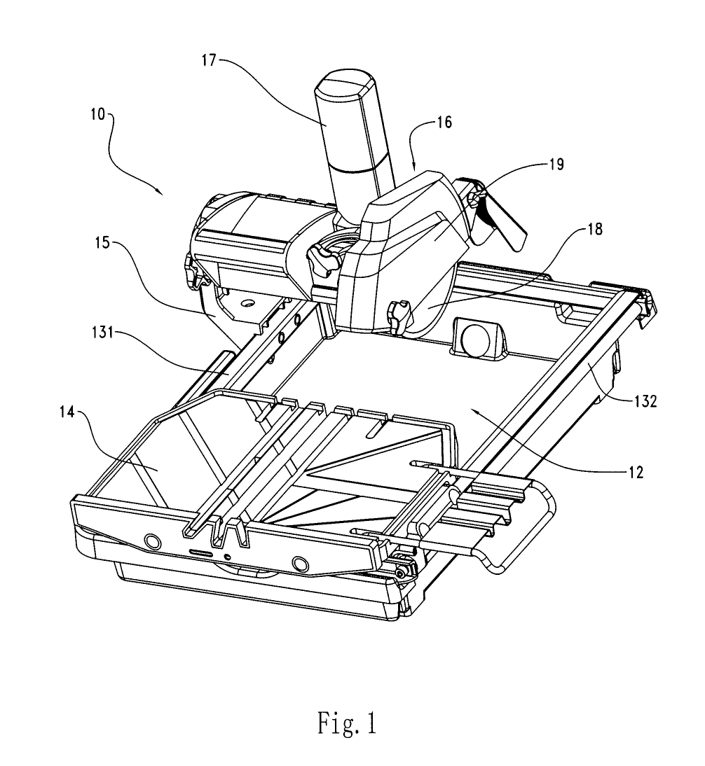

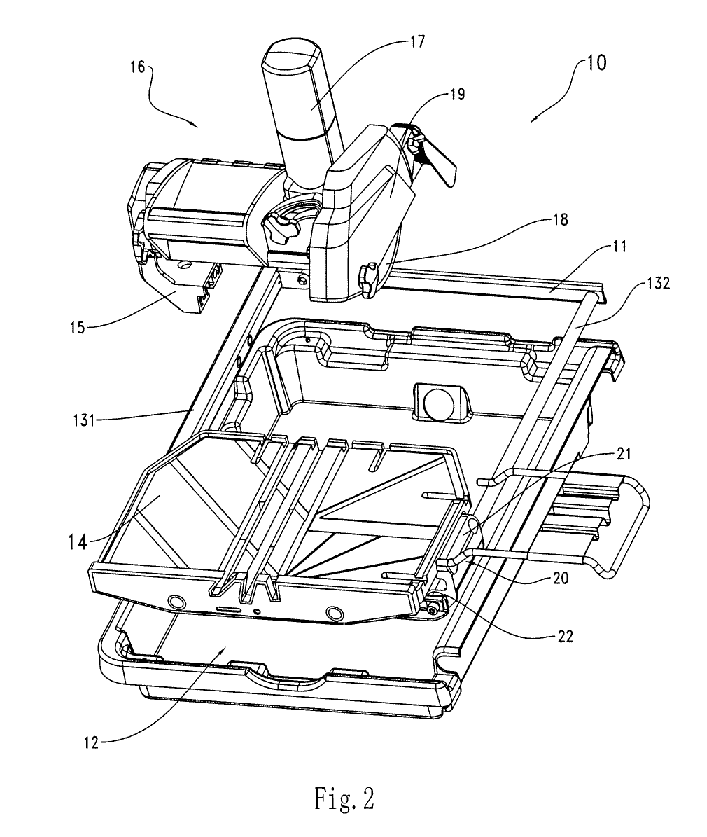

Referring to FIGS. 1 and 2, a tile saw 10 comprises a frame 11, a water tray 12, a table 14, a supporting arm 15 and a cutting device 16. The water tray 12 is located under the table 14 and functions to support the frame 11. The table 14 for supporting a work-piece to be cut is located on the frame 11 and supported by the same. In the present invention, the frame 11 is mounted to a first guide rail 131 and a second guide rail 132, which are parallel to each other and are adjacent to two sides of the frame 11. The table 14 is mounted on the guide rails 131, 132 and is slidable along the guide rails 131, 132. The supporting arm 15 is fixed on the first guide rail 131 of the frame 11 and is used to support the cutting device 16. In a preferred embodiment, the cutting device 16 includes a motor 17, a saw blade 18 and a guard 19. The saw blade 18 may be driven by the motor 17 to allow for cutting of a work-piece by the saw blade 18. As a result of the mounting position of the table 14, the cutting direction of the saw blade 18 is parallel to the sliding direction of the table 14 on the guide rails 131, 132.

The table 14 is connected to the first guide rail 131 on one side using a roller or rollers (not shown) located on the bottom surface of the table 14 and connected to the second guide rail 132 on another side by a connecting device 20. The connecting device 20 includes a connecting end 21 connected to the table 14 and a sleeve 22 mounted to the second guide rail 132. The table 14 and the connecting end 21 of the connecting device 20 may be fixedly coupled together by common means of fasteners known to those of ordinary skill in the art, such as screws. As a result, the table 14 is slideably coupled to the second guide rail 132.

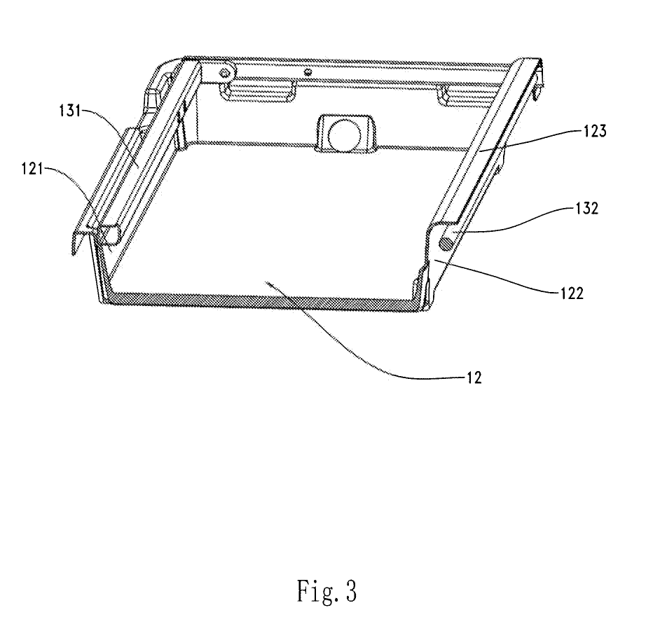

As is shown in FIG. 3, the water tray 12 may include a left side wall 121 and a right side wall 122. The first guide rail 131 may be located inside of the left side wall 121 and the second guide rail 132 may be located outside of the right side wall 122. In a preferred embodiment, the upper end of the right side wall 122 extends outward to form a cantilever portion 123, which is located above the second guide rail 132 and forms a protection device which prevents the second guide rail 132 from being polluted by dirty water or dust produced during operation of the tile saw 10. One of ordinary skill in the art may easily contemplate that in another embodiment, an additional cover element, which is fixed on the right side wall 122 by fasteners such as screws to form a cantilever portion, may also be used to protect the second guide rail 132 from being polluted. Similarly, the first guide rail 131 may also be arranged outside of the water tray 12, and the table may be slideably fixed to the first guide rail 131 by the connecting device with a sleeve, and another protection device may be arranged above the first guide rail 131 to isolate the first guide rail 131 from the dirty water and dust.

The connecting device between the table 14 and the second guide rail 132 is not limited to the above mentioned sleeve 22, and a connecting device constructed with other forms may be used. For example, the track may be arranged on the second guide rail 132, and the sleeve may be replaced with rollers to allow the table to be slideably supported by the second guide rail 132.

The above mentioned embodiments are only exemplary of the concept and principle of the invention and are not meant to be limiting to a specific embodiment of the invention. Those ordinarily skilled in the art will easily contemplate that this invention may have a plurality of other modifications which will still fall within the scope of the present invention.

What is claimed is:

1. A tile saw comprising:
a frame including a first guide rail and a second guide rail;
a water tray located under the frame;
a table for supporting a work-piece slideably supported on at least one of the first and second guide rails;
a supporting arm coupled to the frame;
a rail protection device for protecting at least one of the first and second guide rails;
a cutting device supported by the supporting arm; and,
wherein at least one of the first and second guide rails is located outside of the water tray.

2. The tile saw as claimed in claim 1, wherein the rail protection device is located above at least one of the first and second guide rails.

3. The tile saw as claimed in claim 1, wherein the table is slideably connected to at least one of the first and second guide rails by a connecting device.

4. The tile saw as claimed in claim 3, wherein the connecting device includes a connecting end and a sleeve member.

5. The tile saw as claimed in claim 4, wherein the connecting end is connected to the table, and at least one of the first and second guide rails is mounted in the sleeve member.

6. The tile saw as claimed in claim 1, wherein the rail protection device is directly formed on the water tray.

7. The tile saw as claimed in claim 1, wherein the top portion of one side wall of the water tray extends outward to form the rail protection device.

8. The tile saw as claimed in claim 1, wherein the rail protection device is coupled to the water tray by a fastener.
